(19) United States
(12) Patent Application Publication
(10) Pub. No.: US 2010/0157752 A1
(43) Pub. Date: Jun. 24, 2010

(54) METHOD AND APPARATUS FOR OPTICAL DISC WRITING

(75) Inventors: Gongming Wei, Shanghai (CN); Jianyi Zhong, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,294

(22) PCT Filed: Jun. 27, 2006
(86) PCT No.: PCT/IB06/52112

§ 371 Date: Dec. 20, 2007

(30) Foreign Application Priority Data
Jun. 29, 2005 (CN) 200510081084.7

(51) Int. Cl. G11B 20/00

(52) U.S. Cl. 369/47.15; G9B/20

(57) ABSTRACT

The present invention provides a method and apparatus for optical disc writing. The method provided by the present invention comprises steps: acquiring the writing history information of the optical disc, wherein the data storage area of the optical disc is divided into several writing areas by starting address and ending address of each writing in the history information; selecting a writing area from the plurality of writing areas for the current optical disc writing; determining the write strategy for the optical disc adopted by the current writing for writing the optical disc; and updating the writing history information of the optical disc. According to the method provided by the present invention, the appropriate area can be selected to carry out the optical disc writing, so that the life cycle shortening of the optical disc due to the over-usage of partial recording areas will be avoided, furthermore, the appropriate write strategy can be determined to improve the optical disc writing effects.

### FIELD OF THE INVENTION

The present invention relates to optical storage, and more specifically, to a method and apparatus for optical disc writing.

### BACKGROUND OF THE INVENTION

A Phase-change optical disc, such as CD-RW, DVD-RW and BD-RE, is very popular among customers because it can be over-written thousands of times. The write quality of the Phase-change optical disc is influenced by many factors, such as the quality of the optical disc, the quality of the writing apparatus, the write times of the optical disc and so on. A jitter value is typically used as a parameter to indicate the write quality of the optical disc, that is, the lower the jitter value, the better the write quality of the optical disc. In the DVD+R/RW standard, the jitter denotes the deviation of the data signal relative to the system clock, which is controlled within the range of 9% as required.

Generally, the write quality of optical disc can not be identically good by using the same WS (Write Strategy) parameters to write the same Phase-change optical disc for several times. FIG. 1 is a schematic curve diagram illustrating the relation between the write jitter value and write times of a Phase-change optical disc. As shown in FIG. 1, when the Phase-change optical disc is written for the first time, DOW=0 (Direct Over-Write), the jitter value is relatively low.

When the optical disc is written for the second time, the writing is the direct over-write to the optical disc for the first time. As a result, DOW=1. When DOW=1, the write jitter value of the optical disc increases to a maximum value. While the times of direct over-write exceed 6, the jitter value keeps at a relatively low value. Consequently, the write times have great influence on the quality of the optical disc, especially for the first several times of the optical disc writing.

Generally, the OPC (Optimum Power Control) process needs to be executed before writing an optical disc so as to determine the adopted write strategy for the optical disc. The OPC process is executed in the lead-in zone of the optical disc and under the condition of assuming that the writing executed during the OPC process is the first writing of the area. And thus the write strategy determined by the process is suitable for the second to sixth writing (namely, from DOW1 to DOW5). However, the assumed conditions during the OPC process can not react the write times of the area to be written. As a result, the write strategy determined by the OPC process could not completely satisfy the specific situation of the area to be written.

The optical disc writing for each time is executed from the inner area to the outer area of the optical disc. Consequently, the write times of the most inner area is always far more greater than that of the most outer area, which results in that under some conditions, the life cycle of the inner area has been reached, while the outer area has never been written. As a result, the resources are wasted due to the unreasonable usage.

Thus, a method and apparatus for the optical disc writing needs to be provided to improve the write quality of the optical disc and to take full advantage of the writing resources of the optical disc.

### OBJECT AND SUMMARY OF THE INVENTION

The object of the present invention is to provide a method and apparatus for the optical disc writing to overcome the deficiencies of the prior arts.

According to an embodiment of the present invention, a method for optical disc writing is provided, comprising the steps of: acquiring the writing history information of the optical disc, wherein the data storage area of the optical disc is divided into several writing areas by a starting address and an ending address of each writing in the history information; selecting a writing area from the plurality of writing areas for the current optical disc writing; determining the write strategy for the optical disc adopted by the current writing for writing the optical disc; and updating the writing history information of the optical disc.

The method can further comprise the steps: according to writing history information of the optical disc, counting the writing times that each divided area has been subjected to, so as to be used for selecting the current writing area and determining the write strategy. The selecting of a writing area comprises selecting based on the writing times of an area. The determining the write strategy for the optical disc adopted by the current writing comprises the determining based on the writing history information of the optical disc.

According to an embodiment of the present invention, an optical disc writing apparatus is provided, comprising: an acquiring means, for acquiring the writing history information of the optical disc, wherein the data storage area of the optical disc is divided into several writing areas by a starting address and an ending address of each writing in the history information; a selecting means, for selecting a writing area from the plurality of writing areas for the current writing; a determining means, for determining the write strategy for the optical disc adopted by the current writing for writing the optical disc; and an updating means, for updating the writing history information of the optical disc.

The optical disc writing apparatus can further comprise a counting apparatus for counting writing times that each divided area has been subjected to, so as to be used for selecting the current writing area and determining the write strategy. The selecting apparatus can select based on the writing times of an area. The determining apparatus can determine the write strategy based on the writing history information of the optical disc.

The data storage area is divided into several recording areas by the information of the starting address and ending address of each optical disc writing, wherein the writing times that each recording area has been subjected to are different. According to the present invention, a writing area that is suitable for the current writing is selected and an appropriate write strategy of the optical disc is determined for the current writing, so as to significantly improve the writing effects of the optical disc, adequately use the writing area of the optical area, extend the life cycle of the optical disc, reduce the deviation during selecting the write strategy for the optical disc, and thus the life cycle shortening of the optical disc due to the over-usage of partial writing areas will be avoided.

Other objects and effects of the present invention will become more apparent and easy to be understood from the following description and contents of the claims when taken in conjunction with the accompanying drawings, and with the more comprehensive understanding of the present invention.

### BRIEF DESCRIPTION OF THE DRAWINGS

According to the embodiments, the present invention can be explained in more detail with reference to the accompanying drawings.

FIG. 1 is a schematic curve diagram illustrating the relation between the write jitter value and the writing times of a Phase-change optical disc;

FIG. 2 is a flow chart illustrating a method for optical disc writing according to an embodiment of the present invention;

FIG. 3 is a block diagram illustrating an optical disc writing apparatus according to an embodiment of the present invention; and

FIG. 4 is a schematic diagram illustrating the writing times that the write areas of an optical disc have been subjected to according to an embodiment of the present invention.

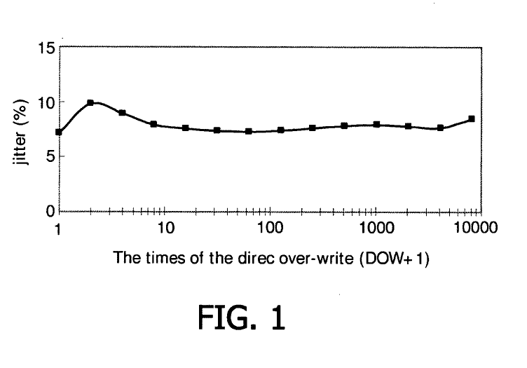

In all the drawings, the same labels denote the similar or corresponding characteristics or functions.

### DETAILED DESCRIPTION OF THE INVENTION

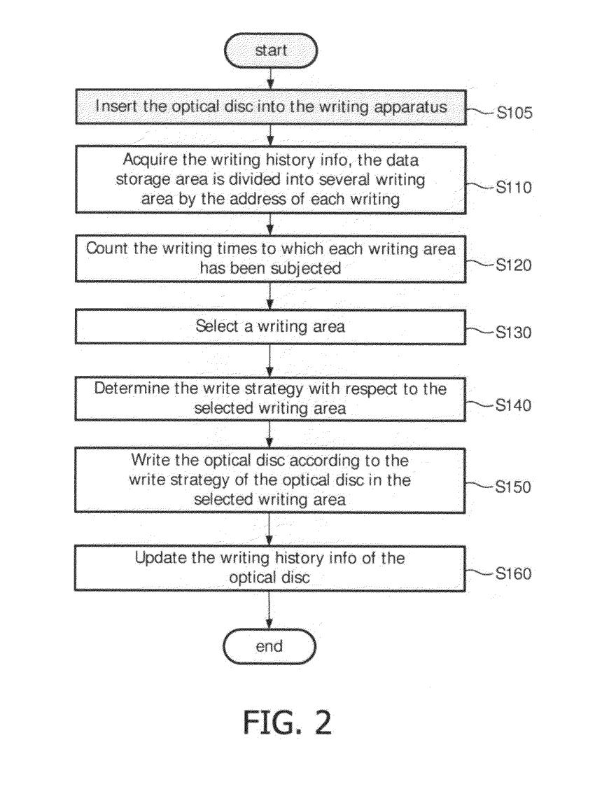

FIG. 2 is a flow chart illustrating a method for a Phase-change optical disc writing according to an embodiment of the present invention. First, a Phase-change optical disc to be written is inserted into an optical disc writing apparatus (Step S105). In the present invention, the optical disc to be written comprises the optical disc which can be over-written, such as CD-RW, DVD+RW, BD-RE and so on.

Then, the optical disc writing apparatus acquires writing history information of the optical disc (Step S110). The writing history information of the optical disc is the history information for each writing prior to the current optical disc writing, which includes the starting address and ending address of each writing, and further comprises the writing times and the adopted write strategy of the optical disc for each writing, and further comprises the times of the OPC that the optical disc has been subjected to. The writing history information of the optical disc can be stored in the optical disc, such as the lead-in zone of the optical disc, and also can be stored in a optical disc management file of the optical disc writing apparatus, or in the other storage media and so on. The data storage area is divided into several writing areas by the starting address and ending address of each writing, namely, the space between any two adjacent addresses (starting address or ending address) is divided as an area.

According to the writing history information of the optical disc, the writing times to which each area has been subjected is counted (Step S120), wherein, each area is divided by the starting address and ending address of each writing. According to the writing history information of the optical disc, the writing times to which a writing area has been subjected can be counted. If an optical disc has been written for n times, while a writing area locates between the starting address and ending address during all the n times writing, then the area has been subjected to the optical disc writing for n times; if a certain writing area locates between the starting address and ending address during the (n-m) times writing, then the area has been subjected to (n-m) times writing. The writing times of the Phase-change optical disc directly influence the adopted write strategy for the writing, as well as the life cycle of the optical disc and the writing effects.

According to the counted writing times, a writing area is selected for current optical disc writing (Step S130). When selecting the writing area, the area, which has been written for fewer times, can be selected as the current writing area, and the writing space needed for the current writing can further be taken into consideration simultaneously. For example, an area of the optical disc has been determined that it has been written only for 20 times while other areas have been written for 30 times, then the area which has been written for 20 times can be selected as the current writing area. However, if the storage space of the selected area is relatively small and far less than the storage space needed for the current writing, then the area in which the writing times is not minimum but the storage space is relatively large can be selected for the current writing. To complete the current optical disc writing within an area can reduce the address transition and changing of the write strategy for the optical disc during the writing.

The write strategy for the optical disc used in current writing is determined with respect to the selected writing area (Step S140). According to the writing times for which the selected area has been written, the OPC process and the corresponding power correction steps, the optical disc write parameters adopted by the current writing is determined. For example, the write strategy of the optical disc for the same writing times in the history information of the optical disc can be referred to. If the current writing is DOW6 writing, and the history information of the optical disc comprises the write strategy for the optical disc adopted by other areas for the DOW6 writing, then the write strategy can be referred to.

If the current writing is the DOW0 writing, or there is no history information for the same writing times in the history information of the optical disc, then before the optical disc writing, the OPC process needs to be executed in the lead-in zone so as to determine the write strategy needed for optical disc writing. If the applied OPC processes can be determined according to the writing history information of the optical disc, then the OPC process can further be applied to the writing test with respect to the selected writing area and the writing times. When determining the write strategy for the optical disc, the write strategy for the optical disc adopted by the adjacent areas for the optical disc writing can further be referred to.

According to the determined write strategy for the optical disc, the optical disc writing is applied to the selected writing area (Step S150). After the writing area and write strategy is determined, the optical disc writing can be executed based on the conventional method. Like the other writing, the current writing also has the corresponding starting address and ending address of the writing, the writing time of the optical disc, the write strategy for the optical disc adopted by the optical disc writing, as well as other information. The forgoing information is used to update the writing history information of the optical disc (Step S160), and is prepared for the later writing.

During the Step S110, the writing history information for each preceding times does not need to be acquired in all conditions. For example, if the writing times of almost all the areas of the whole optical disc are between 100 and 110, the write strategy of the optical disc and jitter value are kept stable, then the major function of the optical disc writing information is counting the writing times, which is used to monitor the life cycle of the optical disc. Consequently, the more flexible method can be adopted, for example, only acquiring the writing history information of 5 or 10 times before the current writing.

According to the method provided by the present invention, the optical disc writing that each area of the optical disc has been subjected to has a corresponding writing history of the optical disc. On the one hand, the writing history can be used to select an appropriate area for optical disc writing instead of restricting to starting from the inner area of the data storage area for each writing, so that the shortening of the life cycle of the optical disc due to the over-written of some specific areas can be avoided. On the other hand, the writing history, associated with OPC process and other correction factors, can be used to determine the write strategy for the selected area instead of restricting to the conventional method that determines the write strategy for the optical disc only by the OPC process in lead-in zone and the assumed conditions. Consequently, the writing effects of the optical disc can be improved.

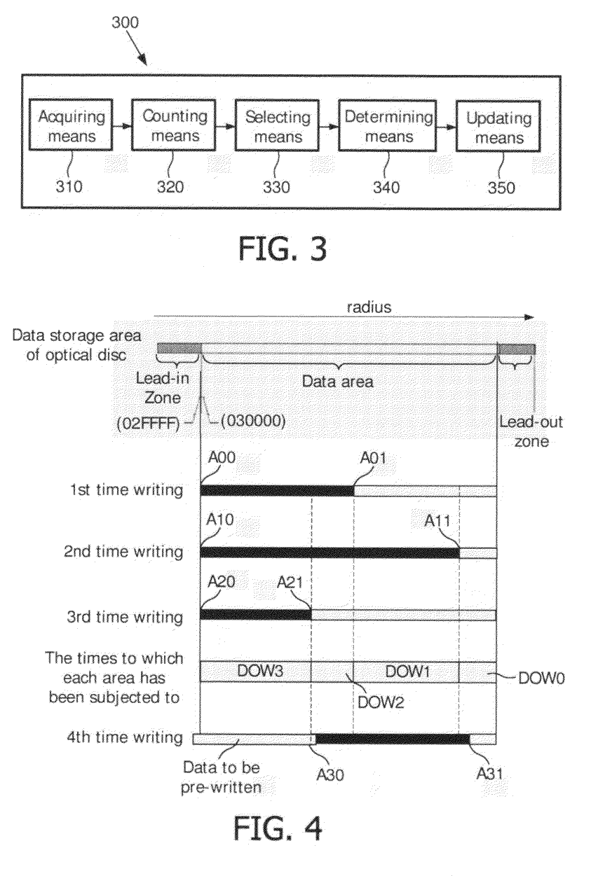

FIG. 3 is a block diagram illustrating an optical disc writing apparatus 300 according to an embodiment of the present invention. The optical disc writing apparatus 300 comprises an acquiring means 310 for acquiring the writing history information of the optical disc. The writing history information of the optical disc comprises the writing history information of the optical disc for each writing prior to the current writing, such as the writing times, the starting address, the ending address and so on. The writing history information of the optical disc can be stored in the optical disc, such as the lead-in zone, or in an optical disc management file of the optical disc writing apparatus. The data storage area is divided into several writing areas by the starting address and ending address of each writing, namely, the space between any two adjacent addresses (starting address or ending address) is partitioned as an area.

The writing apparatus 300 further includes a counting means 320, based on the writing history information of the optical disc, for counting the writing times that each divided area has been subjected to. For example, the writing times that an area has been subjected to can be acquired by subtracting the number of preceding ending addresses of the area from the number of preceding starting addresses of the area.

If the writing history information of the optical disc comprises the writing times of each area that is added after each writing, then the counting means 320 can be omitted. It is not suggested by the present invention to update the writing times of each area immediately after each writing, because the updating of the writing times will cause the storage area that records the writing times to subject a plurality of times of writing, which shortens the life cycle of the area and influences the usage of the whole optical disc.

The optical disc writing apparatus 300 further comprises a selecting means 330 for selecting a writing area from the plurality of writing areas divided by the starting address and ending address of each writing for the current optical disc writing. According to the writing times counted by the counting means 320, the selecting means 330 can select an area which has been subjected to less writing times for the current optical disc writing.

At the same time for the area selecting, the write storage space needed for the current optical disc writing can further be taken into consideration. If the amount of the data for writing is large, then it is not necessary to select the writing area with the minimum writing times, while the area with relatively less writing times but relatively large storage space can be selected for the current writing. Consequently, the problems of the address transition, the changing of the write strategy of the optical disc during the writing and so on can be avoided.

The optical disc writing apparatus 300 further comprises a determining means 340, according to the writing times that the selected area has been subjected to, the OPC process and the corresponding power correction steps, for determining the write strategy adopted by the selected writing area for writing the optical disc. When the write strategy of the optical disc for the current writing is to be determined, the write strategy of the optical disc for the same writing times in the history information of the optical disc can be referred to, and the write strategy of the optical disc adopted by the adjacent areas for the optical disc writing can further be referred to.

The optical disc writing apparatus 300 further comprises an updating means 350 for updating the writing history information of the optical disc. The writing history information of the optical disc needs to be updated after one write and prepared for the next optical disc write. The updating of the writing history information for the optical disc of the present invention comprises adding the starting address and ending address of the current writing area, the write strategy of the optical disc adopted by the current writing, the writing time and so on to the original history information, and further comprises adding a counting information of writing times to the history information, namely, the writing times, including the current writing, to which each recording area partitioned by the starting address and ending address of each writing has been subjected. The writing history information of the optical can further be used to monitor the writing life cycle of the optical disc.

According to the apparatus provided by the present invention, the optical disc writing to which each area of the optical disc has been subjected has a corresponding writing history of the optical disc. On the one hand, the history can be used to select an appropriate area for optical disc writing instead of restricting to the starting of each writing from the inner area of the data storage area, so that the shortening of the life cycle of the optical disc due to the over-written of some specific areas can be avoided. On the other hand, the history, associated with OPC process and other correction factors, can be used to determine the write strategy for the selected area (e.g. the OPC process for the nth recording) instead of restricting to the conventional method that determines the write strategy of the optical disc only by the OPC process in lead-in zone and the assumed conditions. Consequently, the optical disc writing effects can be improved.

FIG. 4 is a schematic diagram illustrating the writing times to which the writing areas of an optical disc have been subjected according to an embodiment of the present invention. As shown in FIG. 4, the data storage area of the optical disc comprises the lead-in zone whose address is before 02FFFF, the data storage area whose address is after 030000 and the lead-out zone. There is no data in the data storage area of the optical disc before the first optical disc writing (DOW0).

The first to the fourth writing of the optical disc is applied to the areas between the address A₀₀ and A₀₁, A10 and A₁₁, A₂₀ and A₂₁ and A₃₀ and A₃₁ respectively. Each writing has the corresponding writing history, which comprises the starting address and the ending address, the writing times of the optical disc, the write strategy of the optical disc for the current optical disc writing and so on.

When the fourth optical disc writing is carried out, the optical disc writing apparatus acquires the address information of the first three writings (DOW0, DOW1 and DOW2). After the first three writings, the data storage area of the optical disc is divided into four areas by the starting address and ending address of the first three writings, as shown in Table 1. Table 1 lists the areas divided by the first three writings and the writing times. In Table 1, the writing times of the next writing for each writing area denotes that if the next writing is carried out in the writing area, then the times is the writing times of the area. For example, if the fourth writing is carried out in the area A≧A₁₁, then the fourth writing is DOW0 writing for the area.

TABLE 1
partitioned areas and writing times after the first three writings

| | | The writing times | writing times DOW of |
|---|---|---|---|
| | | that each area has | each writing area for |
| Area | writing area A | been subjected to | the next writing |
| 1 | A ≧ A₁₁ | 0 | DOW0 |
| 2 | A₀₁ ≦ A < A₁₁ | 1 | DOW1 |
| 3 | A₂₁ ≦ A < A₀₁ | 2 | DOW2 |
| 4 | A₀₀ ≦ A < A₂₁ | 3 | DOW3 |

According to the writing history information of the optical disc, the area A (A≧A₁₁) with relatively less writing times is selected as the writing area, or a relatively large area is selected as the writing area due to the large amount of data of the fourth writing. To further explain the present invention in this embodiment, the area with the starting address A₃₀ (=A₂₁) is selected as the writing area. As shown in FIG. 4, the current writing is actually carried out in three areas: A₃₀≦A<A₀₁, A₀₁≦A<A₁₁, [symbol] A₁₁≦A<A₃₁.

According to the writing history information of the optical disc, to achieve better writing effects, the different segments of the writing area A₃₀ to A₃₁ adopt different write strategy of the optical disc, as shown in Table 2. Table 2 lists the write strategies adopted during the fourth writing, wherein the write strategy is the optimized write strategy for the optical disc during writing the optical disc. The optimized write strategy can be acquired by the OPC process, or by referring to the corresponding correction steps, or further based on the write strategy recorded in the writing history information of the optical disc during the corresponding times writing of the optical disc.

TABLE 2
Schematic table of the write strategy during the 4th writing

| writing area | the write strategy to be adopted |
|---|---|
| A₃₀ ≦ A < A₀₁ | The write strategy adopted during DOW2 writing |
| A₀₁ ≦ A < A₁₁ | The write strategy adopted during DOW1 writing |
| A₁₁ ≦ A < A₃₁ | The write strategy adopted during DOW0 writing |

From the Table 2, when the fourth writing is carried out, the writing area has been divided into three segments. Different segments adopt different write strategies, which are appropriate for the corresponding segments, to improve the writing effects.

According to the present invention, Table 3 is a schematic table that lists a writing history of the optical disc and updating, wherein n denotes the writing times, DOWn can be identical to other DOW The information to be written for each time will be added to the writing history information of the optical disc. The history information will increase gradually with the increase of the writing times. The history information of the Phase-change optical disc can be stored in the lead-in zone of the optical disc, or in a specified area of the optical disc, or in an optical disc management file of the optical disc writing apparatus.

TABLE 3
Schematic table of writing history information of
the optical disc according to the present invention

| | The writing | The writing | The adopted | |
|---|---|---|---|---|
| writing times | starting address | ending address | write strategy | . . . |
| 1^{st} | A₀₀ | A₀₁ | DOW0 | . . . |
| 2^{nd} | A₁₀ | A₁₁ | DOW1 | . . . |
| 3^{rd} | A₂₀ | A₂₁ | DOW2 | . . . |
| . . . | . . . | . . . | . . . | . . . |
| n^{th} | A₍ₙ₋₁₎₀ | A₍ₙ₋₁₎₁ | DOWn | . . . |

When a new writing is carried out, the optical disc writing apparatus reads the stored writing history information of the optical disc. Then, based on the acquired history information, the writing times to which the areas divided by the address of each optical disc writing have been subjected is counted. Next, a writing area is selected, such as the area with the minimum writing times, or the area with less writing times but relatively large space. Next, through the OPC process, or referring to the write strategy for the optical disc with the same times as the current writing, the write strategy of the optical disc adopted by the current writing is determined. Finally, the writing history information of the optical disc is updated, namely, adding to the writing history information of the optical disc, the end point address information, writing times, the write strategy of the optical disc for the current writing and so on.

Table 3 can further comprises the counting information of each writing, for example, the counting for the area division of the data storage area of the optical disc, the writing times to which each area has been subjected and so on, as shown in Table 1. The counting information can directly provide the prepared selecting writing area to the optical disc writing apparatus, but it is not necessary to first analyze the writing history information before each writing.

While the invention has been described with respect to the embodiment, it will be obvious to those skilled in the art that various substitutions, modifications and changes may be made in the above-described embodiment of the present invention. Thus all the substitutions, modifications and changes are within the spirit and scope of the invention as defined in the claims.

1. A method for optical disc writing, comprising steps:
Acquiring writing history information of the optical disc, wherein the data storage area of the optical disc is divided into several writing areas by a starting address and an ending address of each writing in the history information;
Selecting one writing area from the plurality of writing areas for the current writing for the optical disc according to the writing history information;
Determining write strategy of the optical disc adopted by the current writing for writing the optical disc according to the writing history information; and
Updating the writing history information of the optical disc.

2. The method according to claim 1, further comprising steps: according to the writing history information of the optical disc, counting the writing times that each divided area has been subjected to.

3. The method according to claim 2, wherein the step of selecting comprises selecting based on the counted writing times for each area of the optical disc.

4. The method according to claim 3, wherein the step of selecting further comprises selecting based on the storage space needed by data of the current writing for the optical disc.

5. The method according to claim 1, wherein the writing history information further comprises write strategy for the optical disc adopted by each optical disc writing.

6. The method according to claim 1, wherein the write strategy for the optical disc is determined according to the write strategy for the optical disc in the writing history information of the optical disc.

7. The method according to claim 6, wherein the write strategy for the optical disc is determined according to the write strategy for the optical disc for the same writing times in the writing history information of the optical disc.

8. The method according to claim 1, wherein the updating comprises adding the information of the current writing for the optical disc to the writing history information of the optical disc.

9. The method according to claim 8, wherein the information of the current writing for the optical disc comprises the starting address and ending address of the current writing.

10. The method according to claim 9, wherein the information of the current writing for the optical disc further comprises the write strategy for the optical disc adopted by the current writing.

11. An optical disc writing apparatus, comprising:
An acquiring means, for acquiring writing history information of the optical disc, wherein the data storage area of the optical disc is divided into several writing areas by the starting address and ending address of each writing in the history information;
A selecting means, for selecting one writing area from the plurality of writing areas for the current writing of the optical disc according to the writing history information;
A determine means, for determining write strategy of the optical disc adopted by the current writing for writing the optical disc according to the writing history information; and
An update means, for updating the writing history information of the optical disc.

12. The optical disc writing apparatus according to claim 11, further comprising:
A counting means, according to the writing history information of the optical disc, for counting the writing times of the optical disc that each divided area has been subjected to.

13. The optical disc writing apparatus according to claim 12, wherein the selecting comprises selecting based on the counted writing times for each area of the optical disc.

14. The optical disc writing apparatus according to claim 13, wherein the selecting comprises selecting based on the storage space needed by data of the current writing for the optical disc.

15. The optical disc writing apparatus according to claim 11, wherein the writing history information further comprises the write strategy of the optical disc adopted by each optical disc writing.

16. The optical disc writing apparatus according to claim 11, wherein the write strategy of the optical disc is determined according to the write strategy of the optical disc in the writing history information of the optical disc.

17. The optical disc writing apparatus according to claim 16, wherein the write strategy of the optical disc is determined according to the write strategy for the optical disc for the same writing times in the writing history information of the optical disc.

18. The optical disc writing apparatus of claim 11, wherein the updating comprises adding the information of the current writing for the optical disc to the writing history information of the optical disc.

19. The optical disc writing apparatus according to claim 18, wherein the information of the current optical disc writing comprises the starting address and ending address of the current writing.

20. The optical disc writing apparatus according to claim 19, wherein the current optical disc writing information further comprises the optical disc write strategy adopted by the current writing.
